(19) United States
(12) Patent Application Publication
(10) Pub. No.: US 2012/0127526 A1
(43) Pub. Date: May 24, 2012

(54) PRINTER CONTROL APPARATUS, PRINTING METHOD AND PRINTING SYSTEM

(75) Inventors: Hideharu Onishi, Shiojiri-shi (JP); Shinji Nozawa, Minowa-machi (JP)

(73) Assignee: SEIKO EPSON CORPORATION, Shinjuku-ku (JP)

(21) Appl. No.: 13/300,376

(22) Filed: Nov. 18, 2011

(30) Foreign Application Priority Data
Nov. 19, 2010 (JP) 2010-258650
Nov. 19, 2010 (JP) 2010-258652

(51) Int. Cl. G06K 15/02

(52) U.S. Cl. 358/1.15

(57) ABSTRACT

Provided is a printer driver including: a first function which generates a first printing job which prints a document; a second function which generates a second printing job which prints information on the first printing job; a third function which outputs the second printing job; a fourth function which outputs the first printing job; a fifth function which determines whether or not a next to-be-printed document is present; a function which repeats the first function to the fifth function in the case where it is determined that the next to-be-printed document is present by the fifth function; and a function which performs the third function in the case where it is determined that the next to-be-printed document is absent by the fifth function.

### CROSS REFERENCES TO RELATED APPLICATIONS

The present invention contains subject matter related to Japanese Patent Application Nos. 2010-258650 filed in the Japanese Patent Office on Nov. 19, 2010 and 2010-258652 filed on Nov. 19, 2010, the entire contents of which are incorporated herein by reference.

### BACKGROUND

1. Technical Field

The invention relates to a printer control apparatus, a printing method, a printing system, and a recording medium.

2. Related Art

In a case where one user prints a plurality of documents by using a printer or the case where a plurality of users prints the documents by using a printer connected to a network, the documents of which the printing is commanded by the user are sequentially printed on sheets and the printed sheets are discharged from a discharging unit. However, in the case where one document includes a plurality of pages, since a bundle of printed documents is stacked in the discharging unit, it is not easy to extract only a desired document from the bundle of the documents. In order to solve this problem, JP-A-10-143017 discloses a printing apparatus for generating a slip sheet where information on the document is printed on a surface where the document is not printed and discharging the generated slip sheet at a position between the documents so as to easily extract the desired document. In addition, disclosed is a technique for printing a slip sheet at the starting and ending portions of a document printed by a user so that the contents of the document may not be seen by a third party.

However, in the case where the documents are sequentially printed, since the slip sheets are printed at the starting and ending portions of the documents, the slip sheet of the starting portion of the document and the slip sheet of the ending portion of the document printed previously by one document are subsequent to each other; and the slip sheet of the ending portion of the document and the slip sheet of the starting portion of the next printed document are subsequent to each other. Therefore, with respect to the bundle of the documents, the slip sheets are printed between the documents in an overlapped manner, so that too many printing sheets are consumed.

In addition, recently, many printing apparatuses having a function of printing on both sides of a sheet have been provided. When the slip sheet is to be identified through bending the one side of the bundle of the documents printed on both sides, in the case where the side of the surface where the slip sheet is not printed is bent, it may not be possible to extract the slip sheet. In this case, in order to extract the slip sheet, since the rear side of the one side of the bundle of the documents is necessarily bent again, time and labor are necessarily taken for extracting the desired document among the bundle of the documents.

### SUMMARY

An advantage of some aspects of the invention is to suppress consumption of printing sheets and to output a slip sheet for preventing leakage of contents of a printed document.

Another advantage of some aspects of the invention is to easily identify and extract a desired document among a bundle of documents.

The invention is contrived to obtain the aforementioned advantages and is embodied by the aspects or application examples described hereinafter.

According to a first aspect of the invention, there is provided a printer control apparatus including: a first function which generates a first printing job which prints a document; a second function which generates a second printing job which prints information on the first printing job; a third function which outputs the second printing job; a fourth function which outputs the first printing job; a fifth function which determines whether or not a next to-be-printed document is present; a function which repeats the first function to the fifth function in the case where it is determined that the next to-be-printed document is present by the fifth function; and a function which performs the third function in the case where it is determined that the next to-be-printed document is absent by the fifth function.

According to these functions, the first printing job which prints the document is generated, and after the second printing job which prints the information on the first printing job is generated and output, the first printing job is output. In addition, in the case where the next to-be-printed document is present, the first printing job which prints the next document is generated; after the second printing job which prints the information on the first printing job is generated and output, the first printing job is output; and these printing jobs are sequentially repeated until the next to-be-printed document is absent. In addition, in the case where it is determined that the next to-be-printed document is absent or the case where the next to-be-printed document becomes absent, the second printing job which prints the information on the last-output first printing job is generated and output. Therefore, in the case where the first printing job which prints the document is subsequently output, the printer driver outputs the second printing job at the starting and ending portions of the plurality of the first printing jobs and, furthermore, prints the second printing job between the two first printing jobs. As a result, in the printing apparatus which receives the printing job, since the information on the printing job is printed between the printing jobs of the plurality of the printing jobs which print the document and at the starting and ending portions of the plurality of the printing jobs, the information on the printing job shields the contents printed on the printing sheet, so that it is possible to suppress consumption of the printing sheets.

In the printer control apparatus according to the aspect described above, it is preferable that the second printing job print the information on the first printing job on both sides of one sheet.

According to these functions, even in the case where the bundle of the documents is bent from any side thereof, it is possible to easily recognize the information on the first printing job.

In the printer control apparatus according to the aspect described above, it is preferable that the second printing job print the information on the first printing job facing the surfaces of the one sheet on the surfaces and, in the case where the one surface does not face the first printing job, print the information on the first printing job facing the rear surface of the one surface on the one surface.

According to these functions, it is possible to easily identify the documents of the printing jobs from the bundle of the documents.

In the printer control apparatus according to the aspect described above, in the case where the next to-be-printed document may not be acquired within a predetermined time, the fourth function may determine that the next to-be-printed document is absent.

In the printer control apparatus according to the aspect described above, the second printing job may print a predetermined color or a predetermined figure.

In the printer control apparatus according to the aspect described above, it is preferable that the printer control apparatus further include a breaking page setting function for determining whether or not the second printing job is generated and output.

According to these functions, it is possible to determine whether or not the second printing job is generated and output.

According to a second aspect of the invention, there is provided a printing method including: generating a first printing job which prints a document; generating a second printing job which prints information on the first printing job; outputting the second printing job; outputting the first printing job; determining whether or not the next to-be-printed document is present; repeating the generating of the first printing job which prints the document, the generating of the second printing job which prints the information on the first printing job, the outputting of the second printing job, the outputting of the first printing job, and the determining whether or not the next to-be-printed document is present, in the case where it is determined that the next to-be-printed document is present by the determining whether or not the next to-be-printed document is present; and performing the outputting of the second printing job in the case where it is determined that the next to-be-printed document is absent by the determining whether or not the next to-be-printed document is present.

According to the method, the first printing job which prints the document is generated, and after the second printing job which prints the information on the first printing job is generated and output, the first printing job is output. In addition, in the case where the next to-be-printed document is present, the first printing job which prints the next document is generated; after the second printing job which prints the information on the first printing job is generated and output, the first printing job is output; and these printing jobs are sequentially repeated until the next to-be-printed document is absent. In addition, in the case where it is determined that the next to-be-printed document is absent or the case where the next to-be-printed document becomes absent, the second printing job which prints the information on the last-output first printing job is generated and output. Therefore, in the case where the first printing job which prints the document is subsequently output, the second printing job is output at the starting and ending portions of the plurality of the first printing jobs and, furthermore, the second printing job is output between the two first printing jobs. As a result, in the printing apparatus which receives the printing job, since the information on the printing job is printed between the printing jobs of the plurality of the printing jobs which print the document and at the starting and ending portions of the plurality of the printing jobs, the information on the printing job shields the contents printed on the printing sheet, so that it is possible to suppress consumption of the printing sheets.

According to a third aspect of the invention, there is provided a printing system, in which, after information on printing of a document is printed and discharged, the document is printed and discharged, wherein in the case where a next to-be-printed document is present, the printing and discharging of the information on the printing of the next to-be-printed document and the printing and discharging of the next to-be-printed document are sequentially repeated until the next to-be-printed document is absent, and wherein in the case where the next to-be-printed document is absent, the information on the printing of the last printed document is printed and discharged.

According to this configuration, in the case where a plurality of the documents is sequentially printed, the information on the printing of the document is printed at the starting and ending portions of the group of the documents, and furthermore, the information on the printing of the document is printed between the two documents. As a result, since the information on the printing of the document is printed between the printed documents and at the starting and ending portions of the group of the documents, the information on the printing of the document shields the contents printed on the printing sheet, so that it is possible to suppress consumption of the printing sheets.

According to a fourth aspect of the invention, there is provided a printer control apparatus including: a first function which generates and outputs a first printing job which prints a document on a sheet; and a second function which generates and outputs a second printing job which prints information on the first printing job on both sides of one sheet after the first printing job is output.

According to these functions, after the first printing job for printing the document is generated and output, the second printing job for printing the information on the first printing job on both sides of the one sheet is generated and output. Therefore, since the printing apparatus input with the output printing job discharges the sheet where the information on the first printing job is printed on both sides thereof after the first printing job is printed on the sheet and the sheet is discharged, even in the case where the bundle of the sheets stacked in the printing apparatus is bent from any side thereof, the break of the sheet where the first printing job is printed may be extracted, so that it is possible to easily extract the sheet where the first printing job is printed among the bundle of the sheets.

In the printer control apparatus according to the aspect described above, it is preferable that the second printing job print first information on a facing surface of the one sheet facing the sheet where the first printing job is printed and print second information on the rear surface of the facing surface.

According to these functions, different information may be printed on the surface facing the sheet where the first printing job is printed and the rear surface thereof.

In the printer control apparatus according to the aspect described above, it is preferable that the first information indicate the end of the first printing job, and the second information indicate the start of the first printing job.

According to these functions, it is possible to extract the break of the sheet where the first printing job is printed and to recognize the sheet where the first printing job is printed among the bundle of the sheets.

In the printer control apparatus according to the aspect described above, at least one of the first information and the second information may indicate a predetermined color or a predetermined figure.

In the printer control apparatus according to the aspect described above, it is preferable that the printer control apparatus include a breaking page setting function for determining whether or not the second printing job is generated and output.

According to these functions, it is possible to determine whether or not the second printing job is generated and output.

According to a fifth aspect of the invention, there is provided a printer control apparatus including: a function which generates a first printing command for printing a document on a sheet; a function which generates a second printing command for printing information on the printing by the first printing command on both sides of one sheet; and a function which generates and outputs a printing job which performs the second printing command subsequently to the first printing command.

According to these functions, the first printing command for printing the document and the second printing command for printing the information on the printing by the first printing command on both sides of the one sheet are generated, and the printing job which performs the second printing command subsequently to the first printing command is generated and output. Therefore, since the printing apparatus input with the output printing job discharges the sheet where the information on the first printing job is printed on both sides thereof after the first printing job is printed on the sheet and the sheet is discharged, even in the case where the bundle of the sheets stacked in the printing apparatus is bent from any side thereof, the break of the sheet where the first printing job is printed may be extracted, so that it is possible to easily extract the sheet where the first printing job is printed among the bundle of the sheets.

According to a sixth aspect of the invention, there is provided a printing method including: generating and outputting a first printing job which prints a document on a sheet; and generating and outputting a second printing job which prints information on the first printing job on both sides of one sheet after the first printing job is output.

According to this method, after the first printing job for printing the document is generated and output, the second printing job for printing the information on the first printing job on both sides of the one sheet is generated and output. Therefore, since the printing apparatus input with the output printing job discharges the sheet where the information on the first printing job is printed on both sides thereof after the first printing job is printed on the sheet and the sheet is discharged, even in the case where the bundle of the sheets stacked in the printing apparatus is bent from any side thereof, the break of the sheet where the first printing job is printed may be extracted, so that it is possible to easily extract the sheet where the first printing job is printed among the bundle of the sheets.

According to a seventh aspect of the invention, there is provided a printing system in which, after a document is printed on a sheet and the printed sheet is discharged, information on the printing of the document is printed on both sides of one sheet and the printed one sheet is discharged.

According to the configuration, since the sheet where the information on the printing of the document is printed on both sides thereof is discharged after the document is printed on the sheet and the sheet is discharged, even in the case where the bundle of the sheets stacked in the discharging outlet is bent from any side thereof, the break of the sheet where the document is printed may be extracted, so that it is possible to easily extract the sheet where the document is printed among the bundle of the sheets.

### BRIEF DESCRIPTION OF THE DRAWINGS

The invention will be described with reference to the accompanying drawings, wherein like numbers reference like elements.

FIG. 1 is a diagram illustrating a configuration of a printing system according to an embodiment of the invention.

FIG. 2 is a block diagram illustrating a functional configuration of a printer driver according to the embodiment of the invention.

FIG. 3 is a diagram illustrating an example of a user interface for printing setting.

FIG. 4 is a flowchart illustrating a procedure of a printing process of a printer driver.

FIG. 5 is a flowchart illustrating a procedure of a both-side printing process of a breaking page according to a first embodiment.

FIG. 6 is a diagram illustrating an example of printing of the breaking page according to the first embodiment.

FIG. 7 is a flowchart illustrating a procedure of a printing process of a breaking page according to a second embodiment.

FIG. 8 is a diagram illustrating an example of a breaking page discharged according to the second embodiment.

### DESCRIPTION OF EXEMPLARY EMBODIMENTS

Hereinafter, a printing system which generates and discharges a breaking page will be described with reference to the drawings.

### First Embodiment

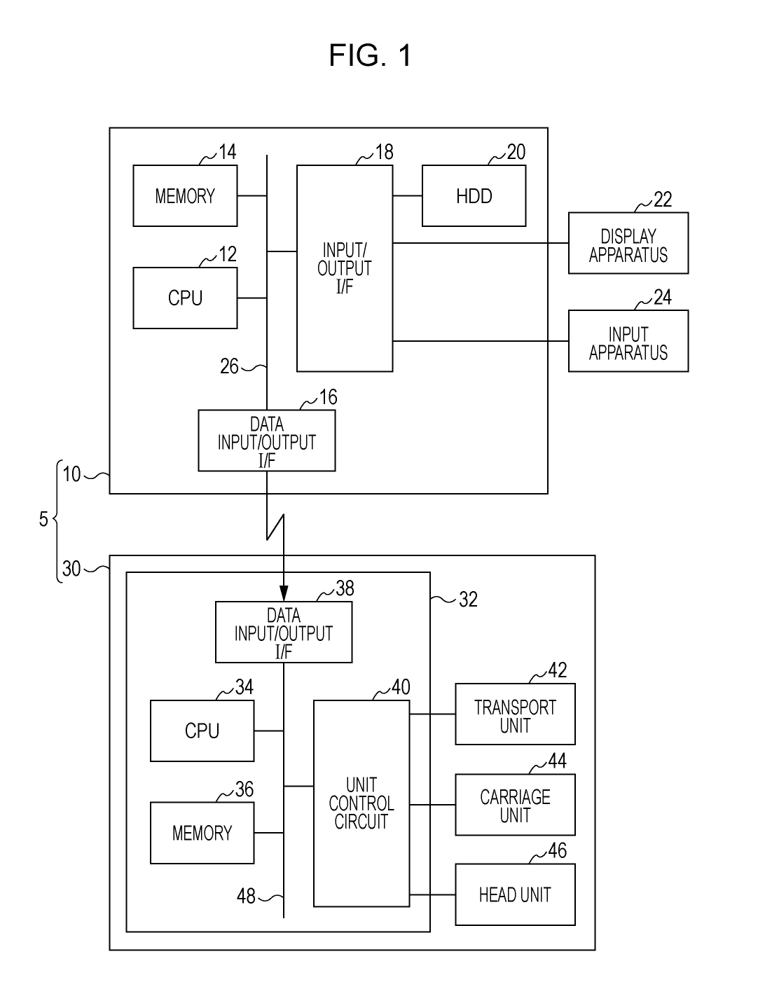

FIG. 1 is a diagram illustrating a configuration of a printing system 5. The printing system 5 is configured so that a computer 10 as a host apparatus and a printer 30 as a printing apparatus are connected in a communicatable manner.

The computer 10 includes a CPU (Central Processing Unit) 12 as main hardware for a calculation process. The CPU 12 may access a memory 14 such as a ROM (Read Only Memory) or a RAM (Random Access Memory) through a system bus 26. In addition, an input/output I/F 18 and a data input/output I/F 16 are connected to the system bus 26.

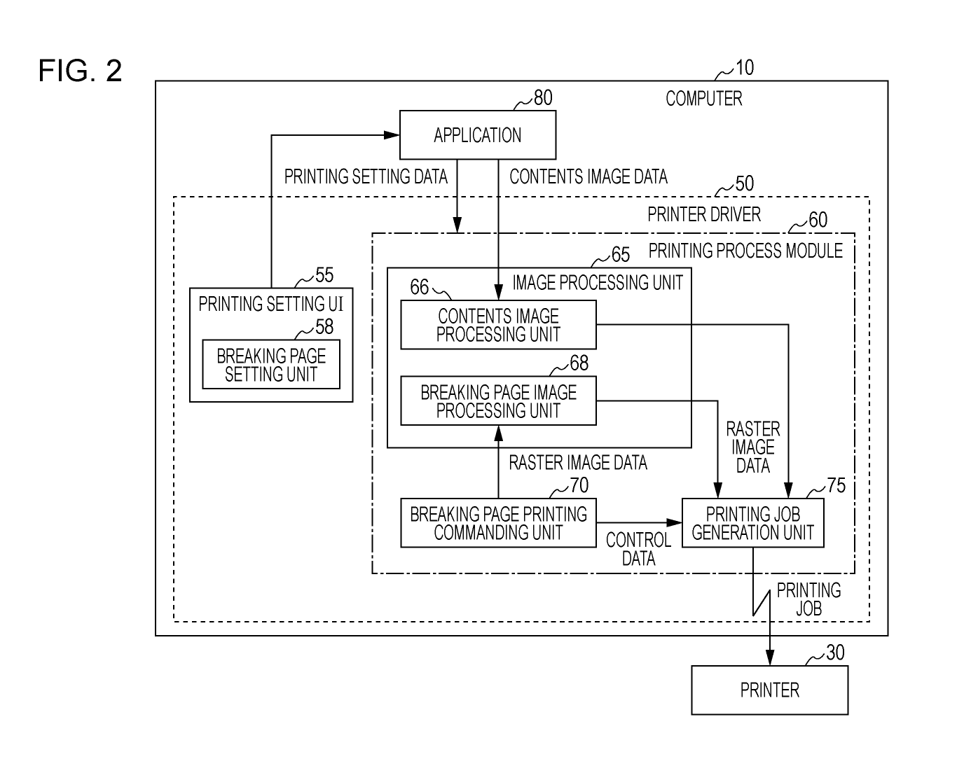

An HDD 20 as an external storage apparatus is connected to the input/output I/F 18. An operating system (not shown), a printer driver 50 (FIG. 2) which controls a function of the printer 30 and generates printing data according to the function of the printer 30, an application 80 (FIG. 2) which may generate the document such as document information or image information, and the like as software are stored in the HDD 20. The software is appropriately transmitted to the RAM of the memory 14 by the CPU 12 at the time of execution thereof. The CPU 12 appropriately accesses the RAM to execute the software. In other words, the RAM is used as a temporary work area, in which various programs are executed.

In addition, a display apparatus 22 which displays an image or character information and an input apparatus 24 such as a keyboard or a mouse which is input with command information according to user's manipulation are connected to the input/output I/F 18.

With respect to the data input/output I/F 16, the connection through, for example, a USB (Universal Serial Bus) is considered. The data input/output I/F 16 outputs data of a printing job generated by the printer driver 50 to the printer 30, or information on a status from the printer 30 is input thereto. In addition, with respect to the connection to the printer 30, a form of connection through a network may also be considered.

The printer 30 includes a controller 32, a transport unit 42, a carriage unit 44, and a head unit 46. In the embodiment, with respect to a printing type of the printer 30, an ink jet type is considered. In the case where the printer 30 receives the data of the printing job from the computer 10, the controller 32 controls the transport unit 42, the carriage unit 44, and the head unit 46 to form an image on a printing sheet by ejecting ink droplets from nozzles of a printing head (not shown).

The controller 32 is a control unit for performing controlling the printer 30. The data input/output I/F 38 is configured to perform the data transmission/reception with respect to the computer 10. The CPU 34 performs controlling the overall printer 30. In addition, the memory 36 is configured to secure an area which stores a program of the CPU 34, a job area, or the like. The CPU 34 controls each of units through a unit control circuit 40. These components are connected to each other through a bus 48.

The transport unit 42 transports the printing sheet to a printable position and transports the printing sheet by a predetermined transport amount in a transport direction during a printing period. The carriage unit 44 moves the printing head in a direction intersecting the transport direction. The head unit 46 includes the printing head and drives piezo elements corresponding to nozzles to form an image by ejecting the ink droplets on the printing sheet.

FIG. 2 is a block diagram illustrating a functional configuration of the printer driver 50. The printer driver 50 includes a printing setting UI (User Interface) 55 through which a user performs printing setting and a printing process module 60 which generates the printing job.

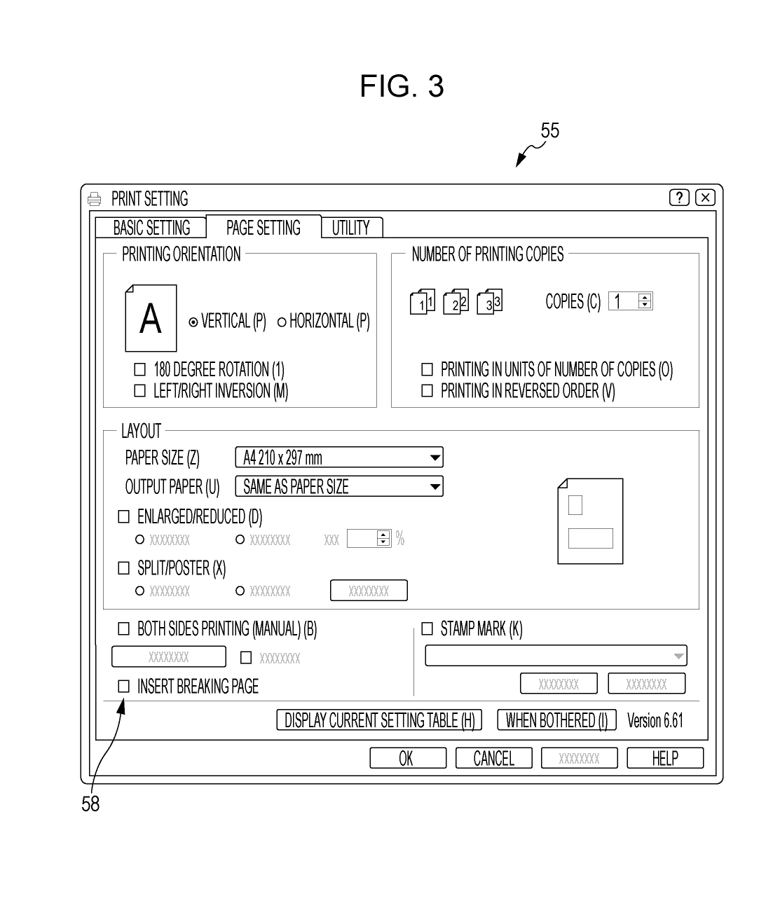

The printing setting UI 55 is a user interface through the user performs the printing setting with respect to the printer driver 50. In the embodiment, a user interface illustrated in FIG. 3 is considered. The printing setting UI 55 includes a breaking page setting unit 58 having a breaking page setting function. The breaking page is also called a slip sheet or a job separator and is configured to indicate a break of the printing job by outputting a printing sheet at the starting and ending portions of the printing job. In FIG. 3, it may be selected by a check box whether or not the breaking page is inserted.

In addition, in the embodiment, although the printer driver 50 has various functions besides the insertion of the breaking page, these functions are not disclosed, and only the function of the breaking page is disclosed.

Information on whether or not to insert the breaking page determined by the printing setting UI 55 is stored in a predetermined storage area called DevMode or a print ticket in response to the operating system. The information in the predetermined storage area is referred to by the application 80 if necessary.

The application 80 has a function of generating the contents image such as a document or an image. The user may generate a desired contents image and commands printing by using the application 80. The application 80 receives a printing command from the user to acquire the printing setting information stored in the storage area by referring to the predetermined storage area and to generate vector image data of the contents image having a predetermined size based on the printing setting information. The application 80 transmits the generated vector image data and the printing setting data to the printing process module 60.

The printing process module 60 includes an image processing unit 65, a breaking page printing commanding unit 70, and a printing job generation unit 75. In addition, the image processing unit 65 includes a contents image processing unit 66 and a breaking page image processing unit 68.

The contents image processing unit 66 has a function of acquiring the vector image data of the contents image transmitted from the application 80 and performing an image process on a vector image indicated by the acquired vector image data to convert the vector image into an RGB (Red Green Blue) raster image. In addition, the contents image processing unit 66 converts the RGB raster image into a CMYK (Cyan Magenta Yellow Black) raster image by applying a three-dimensional Lookup table or an interpolation method. The data (raster image data) of the converted contents raster image are transmitted to the printing job generation unit 75.

The breaking page image processing unit 68 acquires job information (information on the printing job), which is determined in advance by referring to the printing setting data of the contents image or the like recently processed by the contents image processing unit 66, based on a breaking page image generation command transmitted from the breaking page printing commanding unit 70 to generate a raster image including the acquired job information.

In the embodiment, as the job information, information on a printing job name, a user name, a printing date and time, and the like is considered. In addition, in the case where the breaking page image processing unit 68 receives a command of both-side generation of a breaking page image from the breaking page printing commanding unit 70, the breaking page image processing unit 68 generates raster images corresponding to both sides.

For example, it may be configured that a raster image indicating that the facing printing job is one printing job is generated on the breaking page at the side facing the one printing job, and a raster image indicating that the facing printing job is the other printing job is generated on the breaking page at the side facing the other printing job. In addition, it may be configured that a raster image indicating the information on the printing job facing the rear side is generated on the breaking page at the side which does not face the printing job.

In addition, such a process of generating the raster image of the text character line determined in advance in a stamp mark printing function may be applied as the process of generating a raster image from character line data in an inner portion of the printer driver 50. The data (raster image data) of the raster image of the job information generated in this manner are transmitted to the printing job generation unit 75.

In the case where the breaking page printing commanding unit 70 analyzes the printing setting data and determines that the breaking page is to be inserted, the breaking page printing commanding unit 70 transmits the breaking page image generation command to the breaking page image processing unit 68 in order to print a one-sheet breaking page subsequently to the printing of the contents image, generates control data for printing the breaking page based on the printing setting data, and transmits the generated breaking page control data to the printing job generation unit 75.

In the embodiment, the breaking page printing commanding unit 70 transmits the generation command so that the breaking page may be printed at the starting and ending portions of the printing job. In this case, in the case where another printing job is printed subsequently to the printing of the one printing job, the last breaking page is not printed, but only the first breaking page is printed. In the embodiment, the determination whether or not another printing job is present is performed based on whether or not vector image data of the next to-be-printed contents are transmitted within a predetermined time by a timer, the invention is not limited thereto. For example, the determination may be performed based on whether or not a memory temporarily storing the vector image data is empty.

In addition, in the embodiment, the breaking page printing commanding unit 70 determines whether or not the printer 30 may perform both-side printing. In the case where the both-side printing may be performed, the breaking page printing commanding unit 70 commands the breaking page image processing unit 68 to perform both-side generation of the breaking page image. On the other hand, in the case where the printer 30 may not perform the both-side printing or the user selects a setting where the both-side printing is not performed, the breaking page printing commanding unit 70 commands the breaking page image processing unit 68 so that the breaking page image is printed on one side of the printing sheet.

In the case where the raster image data of the contents are transmitted from the image processing unit 65, the printing job generation unit 75 generates the control data based on the printing setting data, combines the generated control data with the raster image data to convert the control data into a command group which may be recognized by the printer 30, and generates a printing job (first printing job) where the converted command group is described in units of a page. The generated printing job is transmitted to the printer 30, and the printer 30 prints the contents image in units of a page based on the printing job.

In addition, in the case where the raster image data of the job information are transmitted from the image processing unit 65, the printing job generation unit 75 combines the control data transmitted from the breaking page printing commanding unit 70 with the generated control data and the raster image data to convert the control data into a command group which may be recognized by the printer 30 and generates a printing job (second printing job) where the converted command group is described in units of a page. The generated printing job is transmitted to the printer 30, and the printer 30 prints the job information as one-sheet breaking page based on the printing job.

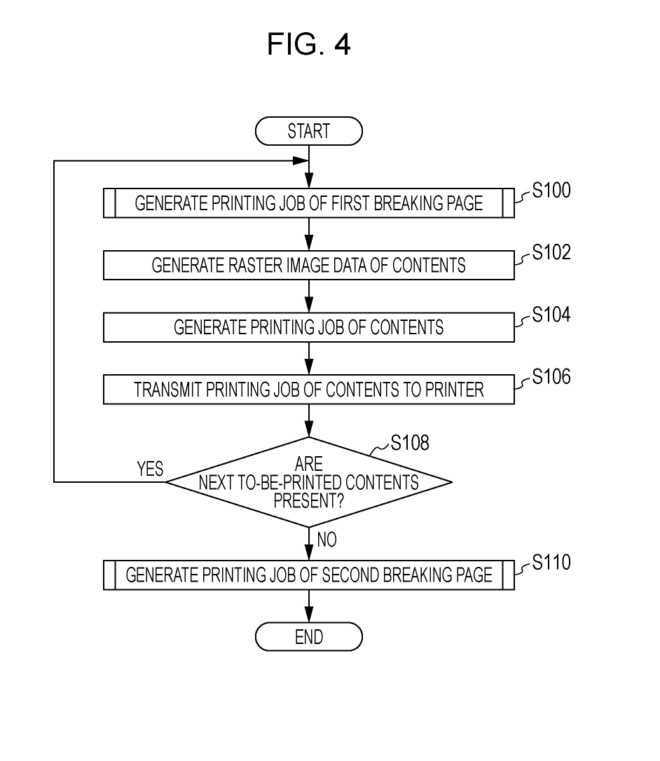

FIG. 4 is a flowchart illustrating a procedure of a breaking page printing process of the printer driver 50. The process is performed in the case where the vector image data of the to-be-printed contents are transmitted from the application 80.

If the process is performed, the CPU 12 of the computer 10 first generates the printing job of the first breaking page (Step S100).

Herein, the process of generating the printing job of the breaking page is described based on the flowchart of FIG. 4.

First, the CPU 12 determines whether or not the printer 30 may perform the both-side printing (Step S120).

Herein, in the case where the CPU 12 determines the both-side printing is available (Yes in Step S120), the CPU 12 generates the raster data of the one surface of the breaking page (Step S122).

Subsequently, the CPU 12 generates the raster data of the other surface of the breaking page, that is, the rear side of the one surface (Step S124).

Next, the CPU 12 generates the printing job of the breaking page where the both-side printing is performed (Step S126), and the procedure proceeds to Step S140.

In addition, in Step S120, in the case where it is determined that the printer 30 may not perform the both-side printing (No in Step S120), the CPU 12 generates the raster data of the breaking page (Step S130), generates the printing job of the breaking page (Step S132), and the procedure proceeds to Step S140.

In Step S140, the CPU 12 transmits the generated printing job to the printer 30, the series of processes is ended, and the procedure returns to a calling site (Step S100).

Returning to FIG. 4, the CPU 12 generates the raster image data of the contents (Step S102).

Next, the CPU 12 generates the printing job of the raster image data of the generated contents based on the printing setting information (Step S104).

Subsequently, the CPU 12 transmits the generated printing job to the printer 30 (Step S106).

Next, the CPU 12 determines whether or not the next to-be-printed contents are present (Step S108).

Herein, in the case where it is determined that the next to-be-printed contents are present (Yes in Step S108), the process returns to the first Step S100, and Step S100 to Step S108 are repeated until the next to-be-printed contents are absent.

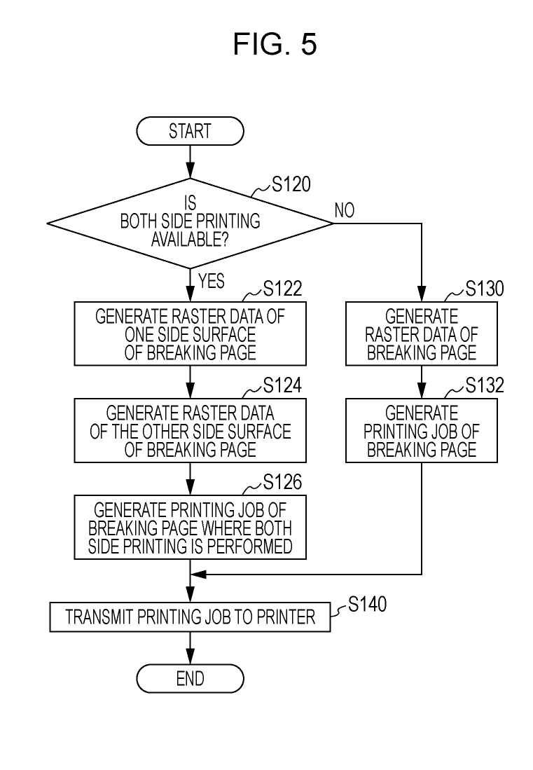

On the other hand, in the case where it is determined that the next to-be-printed contents are absent (No in Step S108), in other words, in the case where the next to-be-printed contents are absent from the beginning or in the case where the next to-be-printed contents become absent by repeating the processes from Step S100 to Step S108, the printing job of the second breaking page is generated (Step S110), and the series of processes is ended. In addition, the process of Step S110 are the same as the process of Step S100 (FIG. 5), and thus, the description thereof is not made.

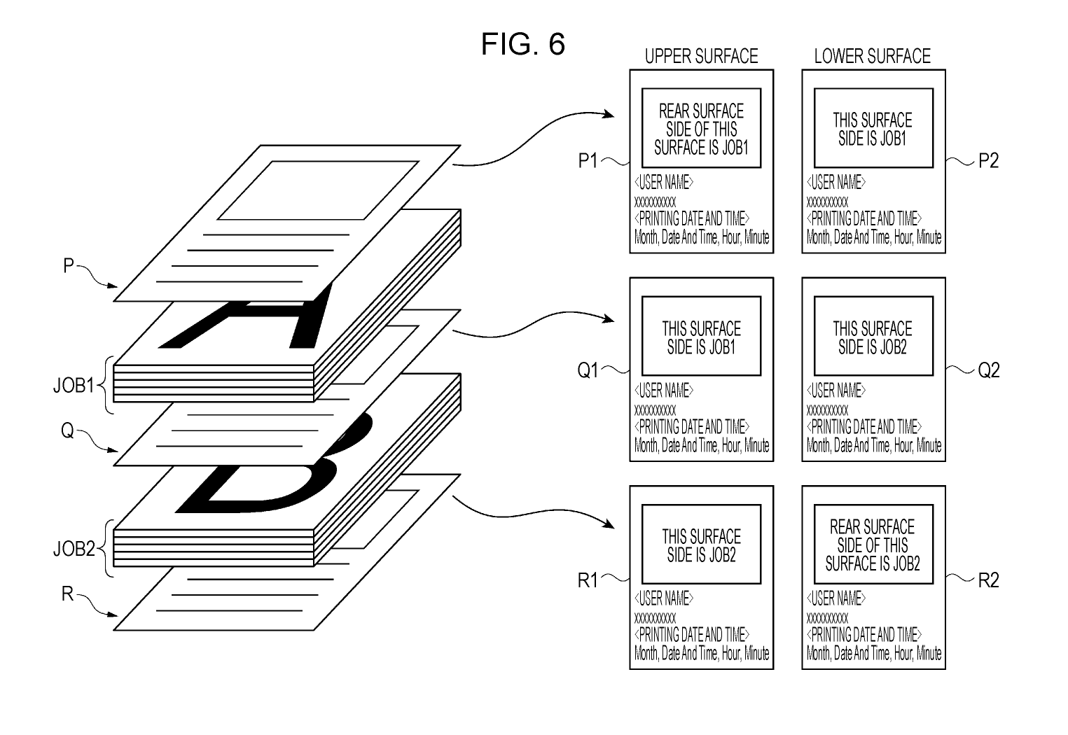

FIG. 6 illustrates an example of the breaking pages P, Q, R printed by the aforementioned processes. In this case, first, the breaking page P is printed; and subsequently, JOB1 is printed; and the breaking page Q is printed. In addition, subsequently, JOB2 is printed, and finally, the breaking page R is printed. The JOB1, the breaking pages P, Q, and R, and the JOB2 printed in this order indicate the state where the JOB1, the breaking pages P, Q, and R, and the JOB2 are extracted so that the JOB1 is at the upper side.

An area where “This surface side is JOB1” is illustrated in a large size and text information indicating a user name and a printing date and time are printed on the lower surface P2 of the breaking page P, that is, the surface facing the printing sheet where JOB1 is printed. In addition, an area where “The rear side of this surface is JOB1” is illustrated in a large size and text information indicating a user name and a printing date and time are printed on the upper surface P1 of the breaking page P, that is, the opposite surface of the lower surface P2.

In addition, an area where “This surface side is JOB1” is illustrated in a large size and text information indicating a user name and a printing date and time are printed on the upper surface Q1 of the breaking page Q, that is, the surface facing the printing sheet where JOB1 is printed. In addition, an area where “This surface side is JOB2” is illustrated in a large size and text information indicating a user name and a printing date and time are printed on the lower surface Q2 of the breaking page Q, that is, the surface facing the printing sheet where JOB2 is printed.

Furthermore, an area where “This surface side is JOB2” is illustrated in a large size and text information indicating a user name and a printing date and time are printed on the upper surface R1 of the breaking page R, that is, the surface facing the printing sheet where JOB2 is printed. In addition, an area where “The rear side of this surface is JOB2” is illustrated in a large size and text information indicating a user name and a printing date and time are printed on the lower surface R2 of the breaking page R, that is, the opposite surface of the upper surface R1.

The breaking page P, the printing sheet of the JOB1, the breaking page Q, the printing sheet of the JOB2, and the breaking page R are stored as one bundle by the user, and in any one of the case where the breaks of the JOB1 and the JOB2 is identified from the breaking page P by flipping and bending the sheets and the case where the breaks of the JOB1 and the JOB2 is identified from the breaking page R, the user may visually recognize character information printed on the breaking page Q. As a result, it is possible to easily separate the JOB1 and the JOB2 from the bundle of the printing sheets. In addition, since the breaking page between the printing jobs is one page, it is possible to suppress consumption of the printing sheets.

Furthermore, the breaking page P, the printing sheet of the JOB1, the breaking page Q, the printing sheet of the JOB2, and the breaking page R are sequentially discharged from the discharging outlet of the printer 30, the breaking page Q becomes the uppermost portion of the bundle of the printing sheets, so that a third party may not easily see the printed contents of the JOB2. Therefore, it is possible to maintain the secrecy of the printed contents.

In addition, there is no limitation to the format of printing the character information on the printing job. In addition, the information printed on the breaking pages P, Q, and R is not limited to the character information, but coloring of a predetermined area with a predetermined color or drawing of a predetermined figure or symbol mark may be used. In addition, the job information written on the breaking pages P, Q, and R is not limited to the printing job name, the user name, and the printing date and time, but the printing setting information or other information which may be acquired from the operating system or the like may be used. Accordingly, it is possible to easily identify the break of the printing job.

In addition, in the embodiment, although the configuration where the printer driver 50 is installed in the computer 10 and the printer driver 50 transmits the generated printing job to the printer 30 which is connected in a communicatable manner is used as the printing system 5, the invention is not limited to this configuration, but a stand-alone type printer 30 such as a multifunctional machine may be considered. In this case, the invention may be applied to a configuration where image data recorded in a memory card or the like are read and the printer driver 50 included in the printer 30 generates a printing job and performs printing.

### Second Embodiment

Next, a second embodiment of the invention will be described. In addition, the configuration of the printing system 5 illustrated in FIG. 1, the configuration of the printer driver 50 illustrated in FIG. 2, and the user interface considered and illustrated in FIG. 3 according to the second embodiment are the same as those of the first embodiment, and thus, the description thereof is not made.

In FIG. 2, the breaking page image processing unit 68 acquires job information (first information), which is determined in advance by referring to the printing setting data of the contents image or the like recently processed by the contents image processing unit 66 based on the breaking page image generation command transmitted from the both-side printing commanding unit 70 to generate a raster image including the acquired job information.

In the embodiment, as the job information, information on a printing job name, a user name, a printing date and time, and the like is considered. In addition, taking into consideration the both-side printing, the breaking page image processing unit 68 generates the data of the first raster image printed on the facing surface which faces the printing sheet where the contents image is printed and the data of the second raster image printed on the rear surface of the facing surface where the first raster image is printed.

In addition, such a process of generating the raster image of the text character line determined in advance in a stamp mark printing function may be applied as the process of generating a raster image from character line data in an inner portion of the printer driver 50. The data (raster image data) of the raster image of the job information generated in this manner are transmitted to the printing job generation unit 75.

In the case where the both-side printing commanding unit 70 analyzes the printing setting data and determines that the breaking page is to be inserted, the both-side printing commanding unit 70 transmits the breaking page image generation command to the breaking page image processing unit 68 in order to print the breaking page subsequently to the printing of the contents image, generates control data for printing the both-side printing through the printing job based on the printing setting data, and transmits the generated both-side printing control data to the printing job generation unit 75.

In the case where the raster image data of the contents are transmitted from the image processing unit 65, the printing job generation unit 75 generates the control data based on the printing setting data, combines the generated control data with the raster image data to convert the control data into a command group (first printing command) which may be recognized by the printer 30, and generates a printing job (first printing job) where the converted command group is described in units of a page. The generated printing job is transmitted to the printer 30, and the printer 30 prints the contents image in units of a page based on the printing job (first function).

In addition, in the case where the raster image data of the job information are transmitted from the image processing unit 65, the printing job generation unit 75 combines the both-side printing control data transmitted from the both-side printing commanding unit 70 with the generated control data and the raster image data to convert the control data into a command group (second printing command) which may be recognized by the printer 30, and generates a printing job (second printing job) where the converted command group is described in units of a page. The generated printing job is transmitted to the printer 30, and the printer 30 performs the printing in units of a page based on the printing job (second function).

In addition, in the embodiment, although the aforementioned two command groups are output through different printing jobs, one printing job may be generated and output so that the first printing command is first performed and subsequently the second printing command is performed.

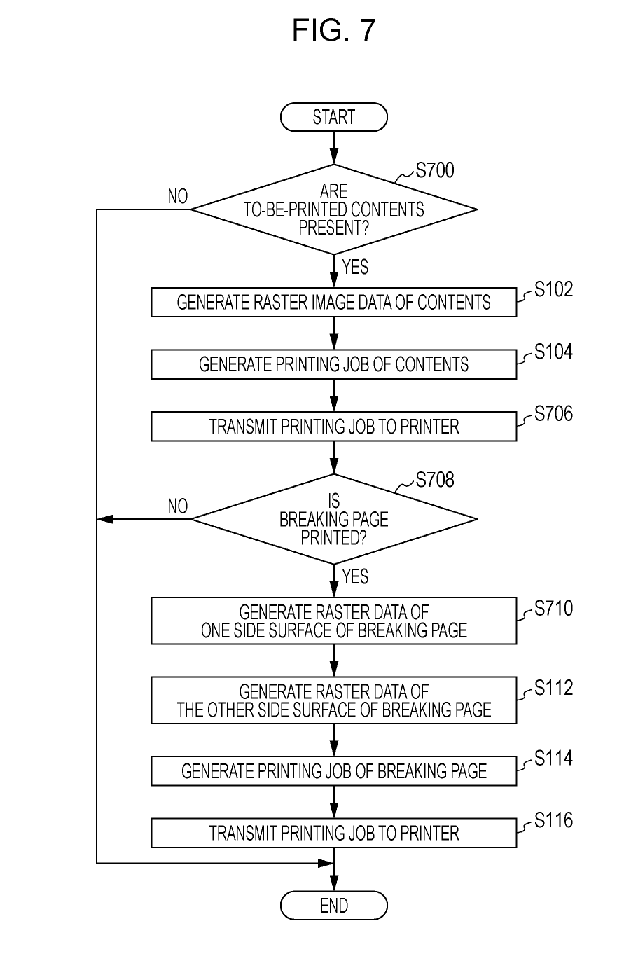

FIG. 7 is a flowchart illustrating a procedure of a breaking page printing process of the printer driver 50. This process is performed at a predetermined time interval by the operating system.

If the process is performed, first, the CPU 12 of the computer 10 determines whether or not the contents which are to be printed by the printer 30 are present (Step S700).

Herein, in the case where the CPU 12 determines that the to-be-printed contents are absent (No in Step S700), a series of the processes are ended.

On the other hand, in the case where the CPU 12 determines that the to-be-printed contents are present (Yes in Step S700), the CPU 12 generates the raster image data of the contents (Step S102).

Next, the CPU 12 generates the printing job of the generated raster image data of the contents based on the printing setting information (Step S104). Subsequently, the CPU 12 transmits the generated printing job to the printer 30 (Step S706).

Next, the CPU 12 determines based on the printing setting information whether or not the breaking page is printed (Step S708).

Herein, in the case where the CPU 12 determines that the breaking page is not printed (No in Step S708), a series of the processes are ended.

On the other hand, in the case where the CPU 12 determines that the breaking page is printed (Yes in Step S708), the CPU 12 generates the raster data of the one surface of the breaking page printed on both sides (Step S710).

Next, the CPU 12 generates the raster data of the other surface of the breaking page printed on both sides (Step S112).

Next, the CPU 12 generates the printing job including the control data relating to the both-side printing and the generated two raster image data based on the printing setting information (Step S114). Subsequently, the CPU 12 transmits the generated printing job to the printer 30 (Step S116), and a series of the processes are ended.

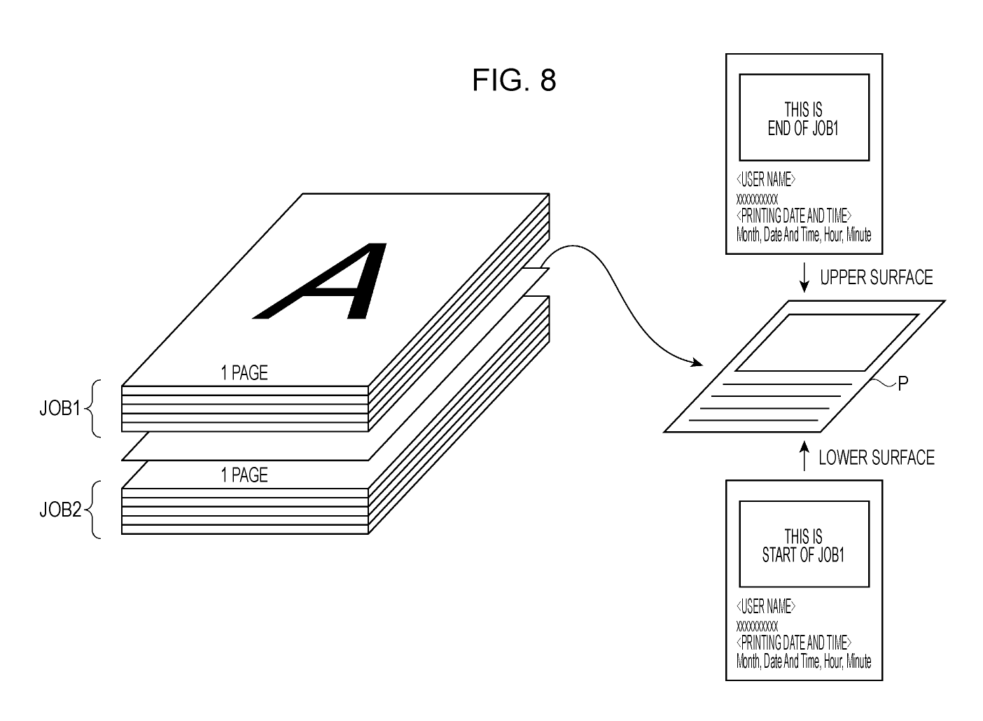

FIG. 8 illustrates an example of the breaking page P printed by the aforementioned processes. The breaking page P illustrated in FIG. 8 is printed after the JOB1 for printing the first contents image is printed. After the breaking page P is printed, the JOB2 for printing the second contents image is printed. The JOB1, the breaking page P, and the JOB2 printed in this order indicate the state where the JOB1, the breaking page P, and the JOB2 are extracted so that the JOB1 is at the upper side.

The first raster image is printed on the upper surface of the breaking page P, that is, the one surface facing the printing sheet of the last page where the first contents image is printed. In addition, the second raster image is printed on the lower surface of the breaking page P, that is, the rear surface where the first contents image is printed.

An area where “This is the end of the JOB1” indicating the ending of the printing job of the JOB 1 is illustrated in a large size and text information indicating a user name and a printing date and time are displayed on the first raster image. In addition, an area where “This is the start of the JOB1” indicating the starting of the printing job of the JOB 1 is illustrated in a large size and text information indicating a user name and a printing date and time are displayed on the second raster image.

Therefore, in the case where a person who stores the printing sheet of the JOB1, the breaking page P, and the printing sheet of the JOB2 as one bundle identifies the breaks of the JOB1 and the JOB2 from the one page of the JOB1 by flipping and bending the sheets, the person may separate the JOB1 and the JOB2 from the bundle of the printing sheets by visually recognizing “This is the end of the JOB1” printed in a large size on the breaking page P. In addition, in the case where the person identifies the breaks of the JOB1 and the JOB2 from the last page of the JOB2 by flipping and bending the sheets, the person may separate the JOB1 and the JOB2 from the bundle of the printing sheets by visually recognizing “This is the start of the JOB1” printed in a large size on the breaking page P.

In addition, in the embodiment, although the break of the page is visually recognized based on the phrases (“This is the end of the JOB1” and “This is the start of the JOB2”) printed in a large size on both sides of the breaking page P, the invention is not limited to the text information, but coloring of a predetermined area with a predetermined color or drawing of a predetermined figure or symbol mark may be used. In addition, the job information written on the breaking page P is not limited to the printing job name, the user name, and the printing date and time, but the printing setting information or other information which may be acquired from the operating system or the like may be used.

In addition, in the embodiment, although the configuration where the printer driver 50 is installed in the computer 10 and the printer driver 50 transmits the generated printing job to the printer 30 which is connected in a communicatable manner is used as the printing system 5, the invention is not limited to this configuration, but a stand-alone type printer 30 such as a multifunctional machine may be considered. In this case, the invention may be applied to a configuration where image data recorded in a memory card or the like are read and the printer driver 50 included in the printer 30 generates a printing job and performs printing.

What is claimed is:

1. A printer control apparatus comprising:
a first function which generates a first printing job which prints a document;
a second function which generates a second printing job which prints information on the first printing job;
a third function which outputs the second printing job;
a fourth function which outputs the first printing job;
a fifth function which determines whether or not a next to-be-printed document is present;
a function which repeats the first function to the fifth function in the case where it is determined that the next to-be-printed document is present by the fifth function; and
a function which performs the third function in the case where it is determined that the next to-be-printed document is absent by the fifth function.

2. The printer control apparatus according to claim 1, wherein the second printing job prints the information on the first printing job on both sides of one sheet.

3. The printer control apparatus according to claim 2, wherein the second printing job prints the information on the first printing job facing the surfaces of the one sheet on the surfaces and, in the case where the one surface does not face the first printing job, prints the information on the first printing job facing the rear surface of the one surface on the one surface.

4. The printer control apparatus according to claim 1, wherein in the case where the next to-be-printed document may not be acquired within a predetermined time, the fourth function determines that the next to-be-printed document is absent.

5. The printer control apparatus according to claim 1, wherein the second printing job prints a predetermined color or a predetermined figure.

6. The printer control apparatus according to claim 1, further comprising a breaking page setting function for determining whether or not the second printing job is generated and output.

7. The printer control apparatus according to claim 1, wherein the document includes any one of document information and image information or both thereof.

8. A printing method comprising:
generating a first printing job which prints a document;
generating a second printing job which prints information on the first printing job;
outputting the second printing job;
outputting the first printing job;
determining whether or not the next to-be-printed document is present;
repeating the generating of the first printing job which prints the document, the generating of the second printing job which prints the information on the first printing job, the outputting of the second printing job, the outputting of the first printing job, and the determining whether or not the next to-be-printed document is present, in the case where it is determined that the next to-be-printed document is present by the determining whether or not the next to-be-printed document is present; and
performing the outputting of the second printing job in the case where it is determined that the next to-be-printed document is absent by the determining whether or not the next to-be-printed document is present.

9. A printing system in which, after information on printing of a document is printed and discharged, the document is printed and discharged,
wherein in the case where a next to-be-printed document is present, the printing and discharging of the information on the printing of the next to-be-printed document and the printing and discharging of the next to-be-printed document are sequentially repeated until the next to-be-printed document is absent, and
wherein in the case where the next to-be-printed document is absent, the information on the printing of the last printed document is printed and discharged.

10. The printer control apparatus according to claim 2, wherein the second printing job prints first information on a facing surface of the one sheet facing the sheet where the first printing job is printed and prints second information on the rear surface of the facing surface.

11. The printer control apparatus according to claim 10, wherein the first information indicates the end of the first printing job, and the second information indicates the start of the first printing job.
